(19) United States
(12) Patent Application Publication
(10) Pub. No.: US 2004/0169076 A1
(43) Pub. Date: Sep. 2, 2004

(54) Biometric based airport access control

(75) Inventors: Richard A. Beale, Mansfield Center, CT (US); Paul D. Benoit, Manchester, CT (US); Joseph B. Shea, Spencer, MA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Accu-Time Systems, Inc., Ellington, CT (US)

(21) Appl. No.: 10/290,810

(22) Filed: Nov. 8, 2002

Related U.S. Application Data
(60) Provisional application No. 60/337,847, filed on Nov. 8, 2001.

(51) Int. Cl. G06K 5/00

(52) U.S. Cl. 235/382

(57) ABSTRACT

One aspect of the invention is a system controlling individual access at an airport. The system comprising an access card having machine readable information of an encoded biometric characteristic. An access control terminal includes a reader for reading the encoded biometric characteristic from the access card. A biometric reader makes a contemporaneous biometric reading of the presenting individual. A processor grants or denies access by comparing the read encoded biometric reading with the presenting individual biometric reading. Another aspect of the invention is controlling entry to commercial vehicles. A biometric reading of a passenger is taken. A boarding pass having the passenger's biometric reading is generated. A contemporaneous biometric reading of each passenger presenting a boarding pass is taken. The presented boarding pass encoded information is compared to a contemporaneous input. Based on the comparison, access is granted or denied.

### CROSS REFERENCE TO RELATED APPLICATION(S)

This application claims priority to U.S. Provisional Patent Application No. 60/337,847, filed Nov. 8, 2001, which is incorporated by reference as if fully set forth.

### FIELD OF INVENTION

The invention generally relates to security. In particular, the invention relates to access control.

### BACKGROUND

Terrorist activities have reinforced the need for high security at airports. One aspect of airport security is access control. If terrorists are allowed access to certain areas of an airport, such as gangways, cockpits, tarmacs, baggage areas, countless lives could be endangered. Accordingly, keeping unauthorized individuals away from these areas is of great importance.

Many airports currently utilized push button style locks to control access to such areas. An individual desiring entry to the areas must push a proper sequence of buttons to gain entry. Although such locks provide some protection, anyone pressing the proper sequence, authorized or unauthorized, can gain access. To illustrate, an unauthorized individual may see the sequence used by a authorized individual and gain access or an authorized individual may tell unauthorized individuals the sequence, breaching security.

Accordingly, it is desirable to have improved access control at airports.

### SUMMARY

One aspect of the invention is a system controlling individual access at an airport. The system comprising an access card having machine readable information of an encoded biometric characteristic. An access control terminal includes a reader for reading the encoded biometric characteristic from the access card. A biometric reader makes a contemporaneous biometric reading of the presenting individual. A processor grants or denies access by comparing the read encoded biometric reading with the presenting individual biometric reading.

Another aspect of the invention is controlling entry to commercial vehicles. A biometric reading of a passenger is taken. A boarding pass having the passenger's biometric reading is generated. A contemporaneous biometric reading of each passenger presenting a boarding pass is taken. The presented boarding pass encoded information is compared to a contemporaneous input. Based on the comparison, access is granted or denied.

### BRIEF DESCRIPTION OF THE DRAWING(S)

FIG. 1 is a flow chart of a preferred access control procedure.

FIG. 2A is a simplified diagram of a stand-alone terminal for airport access control.

FIG. 2B is a simplified diagram of a networked terminal for airport access control.

FIG. 3 is an illustration of a preferred access card.

FIG. 4 is an illustration of a preferred validation procedure.

FIG. 5 is an illustration of an access attempt record.

FIG. 6 is an illustration of a failed access attempt record.

FIG. 7 is an illustration of boarding pass containing biometric information.

FIG. 8 is a simplified diagram of a biometric boarding pass encoding terminal.

FIG. 9 is a flow chart of airline passenger access control.

FIG. 10 is a simplified diagram of a boarding terminal.

### DETAILED DESCRIPTION OF THE PREFERRED EMBODIMENT(S)

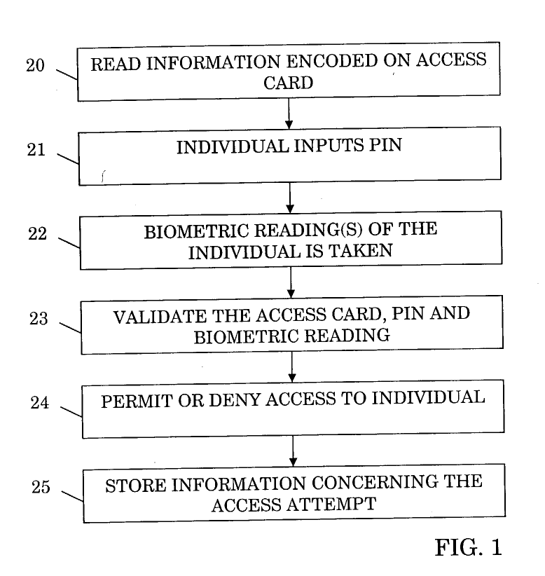

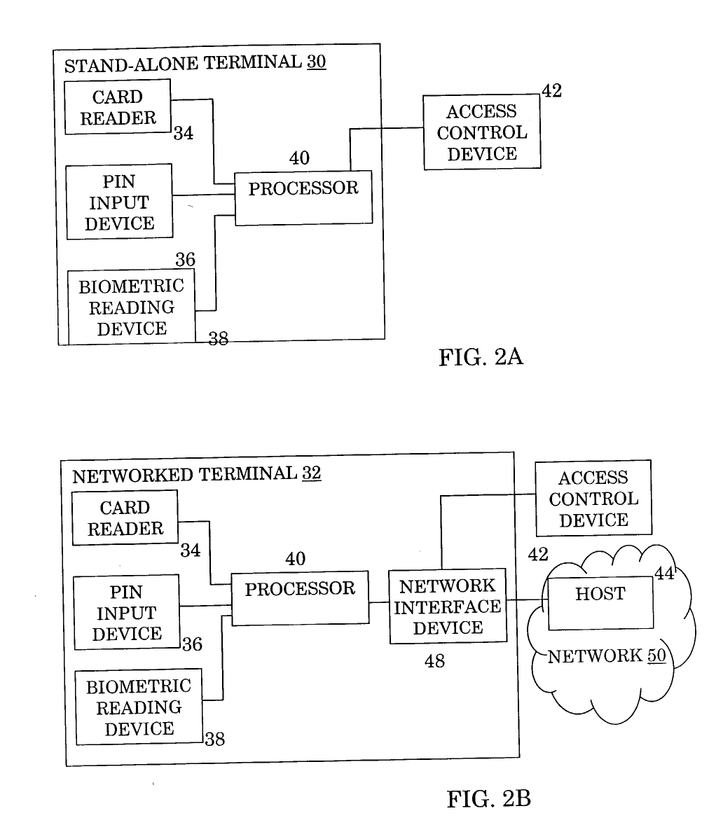

FIG. 1 is a flow chart of a preferred airport access control procedure. Although the preferred use of the invention is for use with the airline industry, it is applicable to other uses. The flow chart of FIG. 1 is explained in conjunction with the preferred stand-alone terminal 30 of FIG. 2A and the preferred networked terminal 32 of FIG. 2B. Access to a restricted area of the airport is controlled by an access terminal 30, 32. The access point, such as a door, controlled by the access terminal 30, 32 has an access point number, such as a door identification number, to identify the access point. Typically, the terminal 30, 32 restricts access to the area by locking and unlocking a door into that area.

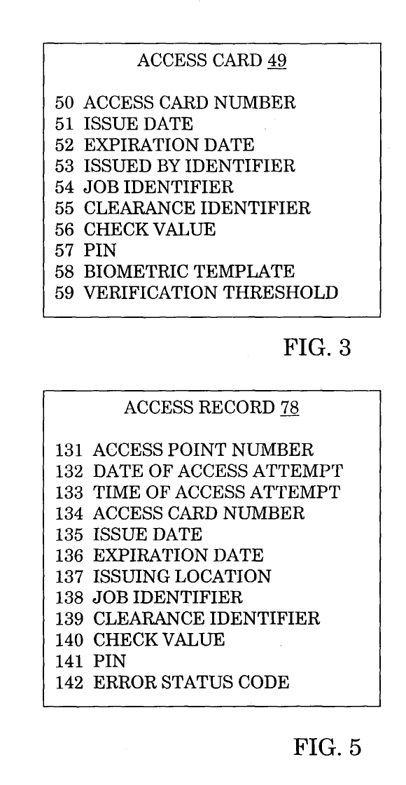

An individual desiring entry into a restricted area has an access card 49 as shown in FIG. 3. The access card 49 is read by a card reader 34 of the access terminal 30, 32, step 20. On the access card 49 is encoded information, such as information encoded on a bar code, magnetic stripe or chip. The read information is transferred to the terminal's processor 40. If the terminal is a networked terminal 32, this information may also be sent to a host computer (host) 44 of a network 50. For the networked terminal 32, the processor 40 sends the information to a network interface device 48, such as a network card. The network interface device 48 converts the information into a format compatible with the network 50, such as a serial, modem or Ethernet network. The converted information is sent through the network 50 to the host 44.

FIG. 3 is an illustration of information stored on a preferred access card 49, although other types of access cards may be used. The access card 49 has an access card number 50, issue date 51, expiration date 52, issued by identifier 53, a job identifier 54, a clearance identifier 55, a check value 56, a personal identification number (PIN) 57, a biometric template 58 and a verification threshold 59.

The access card number 50 is a unique number assigned to the card 49 to distinguish that card 49 from other cards. The issue date 51 identifies the date of issuance of the card 49 to the individual. The expiration date 52 indicates the date that the card 49 expires. The issued by identifier 53 is an indicator of the location that issued the card 49, such as Logan airport in Boston, Mass. The job identifier 54 indicates the job classification of the individual, such as a baggage handler, passenger or pilot.

The clearance identifier 55 indicates the clearance level of the individual. To illustrate, a manager may be given a highest clearance, allowing the manager access to all areas. A baggage handler may have a lower clearance, allowing the baggage handler access only to baggage handling areas. A preferred clearance identifier 55 is a numeric value with a lower number indicating a higher clearance. The clearance identifier 55 is also preferably linked to the job identifier 54. Each job identifier 54 is associated with a particular clearance identifier 55. To illustrate, all baggage handlers have the same clearance identifier 55.

A check value 56 is provided to verify that no tampering has occurred to the card 49. The check value 56 is derived from other information stored on the card 49. If information is altered on the card 49, a check value generated from the altered information will not match the check value 56 stored on the card 49. The individual's PIN 57 is used for comparison with an inputted PIN. The biometric template 58 has information of one or multiple biometric characteristics of the individual. The biometric template 58 is compared to a or multiple biometric reading(s). The verification threshold 59 indicates how close the read biometric information of the individual must match the template 58, such as a 90% match. Although this information is preferably stored on the access card 49, this information may alternately be stored at the access terminal 30, 32 or for a networked terminal 32, sent to the host 44.

After having the card's information read, the individual is prompted to input a PIN. The individual inputs a PIN using a PIN input device 36, such as a numeric keypad, step 21. The inputted PIN is sent to the processor 40. For the networked terminal 32, the inputted PIN may also be sent to the host 44.

Preferably, after inputting the PIN, the individual is prompted to have a biometric reading, such as a finger print, finger geometry, iris, retina or facial characteristic read. For added security, multiple biometric scans may occur, such as finger geometry and facial characteristic. The read biometric information is sent to the processor 40 of the terminal 30, 32 and/or sent to the host 44, step 22.

After receiving the card, PIN and biometric information, the information on the card 49 is validated, step 23. For the stand-alone terminal 30, the validation is performed by the terminal's processor 40. For the networked terminal 32, the validation is performed by either the terminal's processor 40, the host 44 or distributed between them. Initially, the information stored on the card 49 is verified to determine whether the card 49 is valid. This validation includes comparing the access card number 50 against a blacklist. The blacklist indicates access cards 49 no longer permitted access.

After the card 49 is validated, the inputted PIN is compared to the stored PIN 57 to verify that they match. Subsequently, the read biometric reading or biometric readings are compared to the stored reading(s) 58, to verify that they match. If all the information is valid and the inputted information matches the stored information, the individual passes the validation. If any of the information is invalid or does not match, the individual fails the validation.

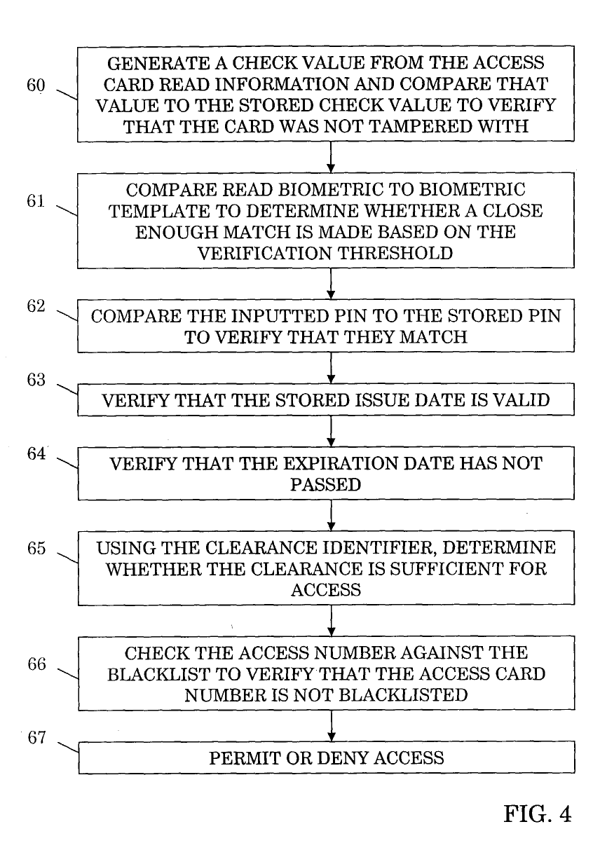

A preferred validation procedure with the access card 49 of FIG. 3 is shown in FIG. 4. From the information read from the access card 49, a check value is generated. The check value is compared to the stored check value 56 to verify that no tampering has occurred to the card, step 60.

After the tampering check, the inputted PIN is compared to the stored PIN 57 to determine whether they match, step 61. Subsequently, the biometric reading or readings are compared to the template 58 to verify that a close enough match as dictated by the verification threshold 59 is met, step 62. The issue date 51 is checked to verify whether a valid date is present, step 63. If the issue date is after the current date, the issue date is not valid. The expiration date 52 is compared to the current date to verify that the card 49 has not expired, step 64.

The clearance identifier 55 is checked to determine whether the individual has adequate clearance to access the area controlled by the access terminal 30, 32, step 65. To simplify the clearance check procedure, preferably, the access point number indicates the clearance identifier 55 required for entrance into that area. To illustrate, an access card 49 has a clearance identifier 55 having a value of five (5). The access card holder is permitted access to any access points having an access point value less than and including 599. If the clearance identifier 55 is four (4), the card holder is permitted access to access numbers less than and including 499. Finally, the access card number 50 is checked against a blacklist to verify that the access card 49 is permitted access, step 66.

After the validation, access to the area is either permitted or denied to the individual, step 24, step 67. If the individual passes the validation, the processor 40 sends a signal to the access control device to allow access, such as by unlocking an access door. If the individual is denied access, the individual is notified of the denial. Preferably, the individual is not provided a reason for the denial. As a result, the individual is not aware of which validation criteria was failed. This procedure prevents an unauthorized individual from attempting to circumvent a particular failed validation criteria.

After a successful access attempt, a record 130 of the access attempt is stored, step 25. FIG. 5 illustrates a preferred access record 130 for use with the access card 49 of FIG. 3. The access record 130 indicates the access point number 131, the date 132 and time 133 of the access attempt, the access card number 134, the issue date 135, the expiration date 136, the issuing location 137 of the access card 49, the job identifier 138, the clearance identifier 139, the check value 140, the PIN 141, and an error status code 142 indicating any errors in the access attempt. Preferably, the error status code is a two byte field with each bit in the error status code 142 representing one potential error.

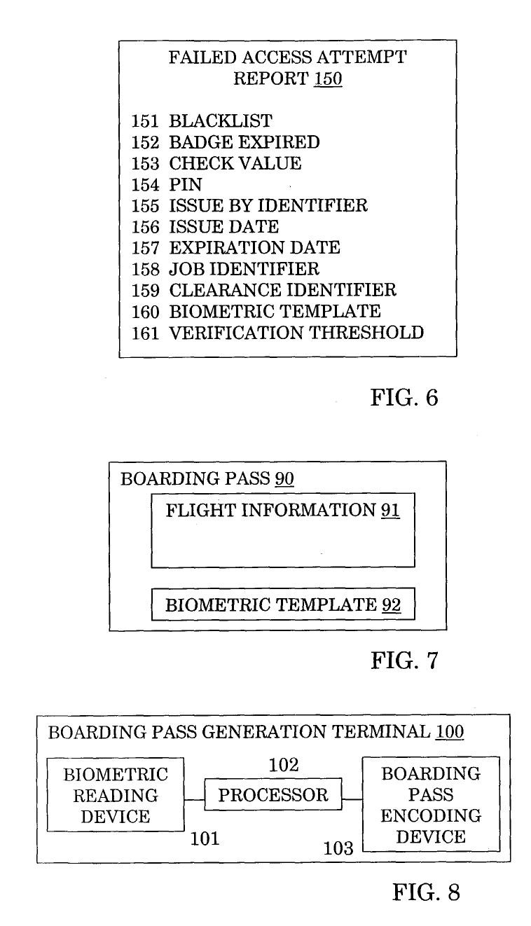

For each failed access attempt, a failed access attempt report 150 is also generated. The failed access attempt report 150 includes an indication of which criteria was not passed. For the card of FIG. 3, a preferred failed access attempt report 150 is shown in FIG. 6. The failed access attempt report 150 includes an identifier of whether the card 49 failed due to the blacklist 151, badge expired 152, check value 153, PIN 154, issue date 156, expiration date 157, clearance identifier 159 or biometric template 160. Also, included in the report 150 is the issued by identifier 155, the job type identifier 158 and the verification threshold 161.

Occasionally, information stored in the terminal 30, 32 must be updated, such as for new employees and updates of the blacklist. To update the validation criteria, the stand-alone terminal 30 may be connected to a host or have information inputted into the terminal 30, such as by a keyboard. After connection to the host 44, information is transferred to the terminal 30. For the networked terminal 32, the information is updated by the host 44 transferring the information to the terminal 32 via the terminal's network interface device 48.

Another aspect of the invention deals with passenger boarding security. Although passenger boarding security is described with the preferred use for airline passenger boarding, passenger boarding security is applicable to boarding in general, such as any commercial vehicle boarding. FIG. 7 is an illustration of a boarding pass 90 containing biometric information. The boarding pass 90 contains conventional flight information 91, such as Airline, flight number, flight time, etc. Additionally, the boarding pass 90 has a stored biometric template 92 of the passenger associated with the boarding pass 90. The biometric template 92 is stored on the boarding pass 90, such as by a bar code, magnetic stripe or chip. One preferred boarding pass 90 is a paper boarding pass with a bar code or magnetic stripe.

FIG. 8 is a preferred terminal 100 for encoding biometric information on to a boarding pass 90. A biometric reading device 101 takes a biometric reading of the passenger. The reading is sent to the terminal's processor 102. The processor 102 converts the biometric reading into a format compatible for storage on the boarding pass 90, such as a bar code or magnetic stripe. A boarding pass encoding device 103 encodes the biometric template 92 of the passenger onto the boarding pass 90. Preferably, the terminal 100 is integrated with the airline's flight information so that the boarding pass encoding device 103 is generating the boarding pass 90 with the flight information 91 along with the encoded biometric template 92.

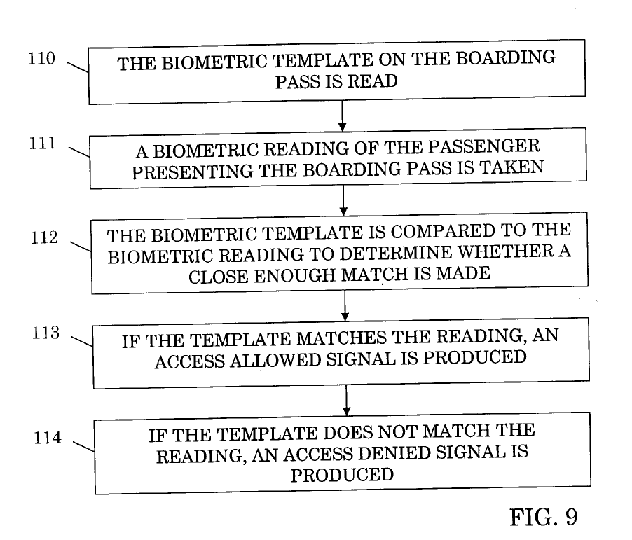

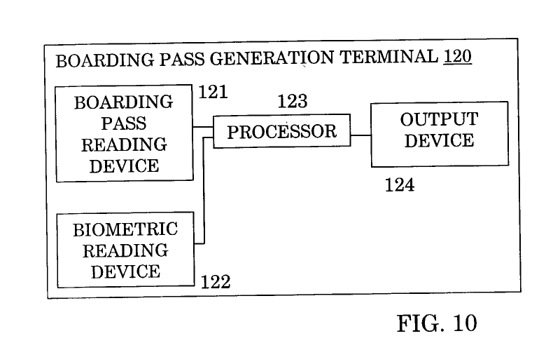

FIG. 9 is a flow chart of the process to allow a passenger to access a plane using the boarding pass 90 with the encoded biometric template 92. The flow chart is described in conjunction with the preferred boarding terminal 120 of FIG. 10. The biometric template 92 on the boarding pass 90 is read by a boarding pass reading device 121, step 110. The read biometric template 92 is sent to the terminal's processor 123.

A biometric reading device 122 takes a biometric reading of the passenger presenting the boarding pass 90, step 111. This reading is also sent to the processor 123 and the processor 123 compares the read biometric information to the passenger's biometric reading to determine whether they match to a specified certainty (threshold), step 112. If they match, the output device 124 outputs an access allowed signal, such as lighting a green light emitting diode (LED), step 113. If the readings do not match, the output device 124 puts out an access denied signal, such as lighting a red LED, step 114. Preferably, the access attempt information is stored in a memory associated with the processor 123.

What is claimed is:

1. A system for controlling individual access at an airport, including:
an access card having machine readable information of an encoded biometric characteristic;
an access control terminal including:
a reader for reading the encoded biometric characteristic;
a biometric reader for making a contemporaneous biometric reading of the presenting individual; and
a processor for granting or denying access by comparing the read encoded biometric reading with the presenting individual biometric reading.

2. The system of claim 1 further comprising a PIN input device for allowing input of a PIN by the presenting individual; wherein the machine readable information includes an encoded PIN, the reader for reading the encoded PIN and the processor compares the read encoded PIN with the presenting individual PIN input to grant or deny access.

3. The system of claim 1 wherein the access card having an access card number and the processor comparing the access card number to a blacklist and denying access if the access card number is on the blacklist.

4. The system of claim 1 wherein the access card having a job identifier indicating a job classification of the presenting individual.

5. The system of claim 4 wherein the access terminal associated with an access point having an access point number, the access point number indicating a numeric values of the clearance identifier permitted access at the associated access point.

6. The system of claim 1 wherein the access card having a clearance identifier and the processor determining whether the clearance identifier allows access by the presenting individual.

7. The system of claim 6 wherein the access card having a job identifier indicating a job classification of the presenting individual and the clearance indicator is derived from the job identifier.

8. The system of claim 1 wherein the access card having a check value and the processor using the check value to determine whether the access card has been tampered with and denying access if determined tampering occurred.

9. The system of claim 1 wherein the access card having a verification threshold for indicating a level of required matching for the comparison of the read encoded biometric reading with the presenting individual biometric reading.

10. The system of claim 1 wherein the comparison of the read encoded biometric reading with the presenting individual biometric reading compares a plurality of read encoded biometric readings with a plurality of presenting individual biometric readings.

11. The system of claim 1 wherein if the presenting individual is denied access, the presented individual is not provided an indication of a specific validation criteria not met.

12. An access control terminal for controlling access at an access point, the access point having an associated access point number, the terminal comprising:
a reader for reading an encoded biometric characteristic, a PIN and a clearance number from an access card;
a PIN input device for allowing input of a PIN by an individual presenting the access card;
a biometric reader for making a contemporaneous biometric reading of the presenting individual; and
a processor for granting or denying access by comparing the read encoded biometric reading with the presenting individual biometric reading, the read encoded PIN with the presenting individual PIN input and the read encoded clearance number with the associated access point number.

13. A method for controlling entry to commercial transportation vehicles comprising the steps of:
taking a biometric reading of a passenger;
generating a boarding pass having the passenger's biometric reading encoded thereon;
taking a contemporaneous biometric reading of each passenger presenting a boarding pass;
comparing the presented boarding pass encoded information to a contemporaneous input; and
granting and denying access based on the comparison.

14. The method of claim 13 wherein the boarding pass for use with airplane boarding.

15. The method of claim 14 wherein the boarding pass includes flight information.

16. The method of claim 13 wherein the boarding pass is a paper boarding pass.

17. A boarding pass for use in boarding a commercial vehicle, the boarding pass comprising:
commercial vehicle information including a time of departure for the commercial vehicle; and
a biometric reading of a passenger allocated the boarding pass; whereby the biometric reading allows for a comparison of a contemporaneously made biometric reading of a potential passenger presenting the boarding pass and the biometric reading of the passenger allocated the boarding pass.

18. The boarding pass of claim 17 wherein the boarding pass for use with airplane boarding.

19. The boarding pass of claim 18 wherein the boarding pass includes flight information and the biometric template is a finger template.

20. The boarding pass of claim 19 wherein the boarding pass is a paper boarding pass.
